(19) United States
(12) Patent Application Publication
(10) Pub. No.: US 2026/0032723 A1
(43) Pub. Date: Jan. 29, 2026

(54) SIDELINK-BASED TRANSMISSION METHOD AND DEVICE, AND READABLE STORAGE MEDIUM

(71) Applicant: VIVO MOBILE COMMUNICATION CO., LTD., Guangdong (CN)

(72) Inventors: Jing LIANG, Guangdong (CN); Xiao XIAO, Guangdong (CN); Qian ZHENG, Guangdong (CN)

(73) Assignee: VIVO MOBILE COMMUNICATION CO., LTD., Guangdong (CN)

(21) Appl. No.: 19/343,607

(22) Filed: Sep. 29, 2025

Related U.S. Application Data
(63) Continuation of application No. PCT/CN2024/085141, filed on Apr. 1, 2024.

(30) Foreign Application Priority Data
Apr. 6, 2023 (CN) 202310367061.0

(51) Int. Cl. H04W 74/0808; H04W 16/14

(52) U.S. Cl. CPC H04W 74/0808; H04W 16/14

(57) ABSTRACT

This application discloses a sidelink-based transmission method and device, and a readable storage medium. The method in embodiments of this application includes: A terminal obtains shared COT through sidelink transmission, and the terminal determines a transmission mode of at least one of data and signaling based on the shared COT.

### CROSS-REFERENCE TO RELATED APPLICATIONS

This application is a continuation application of PCT International Application No. PCT/CN2024/085141 filed on Apr. 1, 2024, which claims priority to Chinese Patent Application No. 202310367061.0 filed on Apr. 6, 2023, which is incorporated herein by reference in its entirety.

### TECHNICAL FIELD

This application belongs to the field of communication technologies, and specifically, to a sidelink-based transmission method and device, and a readable storage medium.

### BACKGROUND

In a sidelink (SL) communication scenario, when two terminals communicate, one terminal may share related parameters with the other terminal, to assist the other terminal in performing sidelink transmission. Currently, it is unclear in the related technology how a terminal uses shared channel occupancy time (shared COT) after receiving the shared COT if the shared COT is introduced to a sidelink.

### SUMMARY

Embodiments of this application provide a sidelink-based transmission method and device, and a readable storage medium.

According to a first aspect, a sidelink-based transmission method is provided, including:
a terminal obtains shared COT through sidelink transmission; and
the terminal determines a transmission mode of at least one of data and signaling based on the shared COT.

According to a second aspect, a sidelink-based transmission apparatus is provided, including:
a first obtaining module, used for obtaining, by a terminal, shared COT through sidelink transmission; and
a first determining module, used for determining, by the terminal, a transmission mode of at least one of data and signaling based on the shared COT.

According to a third aspect, a terminal is provided. The terminal includes a processor and a memory. The memory stores a program or instructions runnable on the processor, and when the program or the instructions are executed by the processor, steps of the method according to the first aspect are implemented.

According to a fourth aspect, a terminal is provided, including a processor and a communication interface. The communication interface is used for obtaining, by a terminal, shared COT through sidelink transmission, and the processor is used for determining a transmission mode of at least one of data and signaling based on the shared COT.

According to a fifth aspect, a readable storage medium is provided. The readable storage medium stores a program or instructions. When the program or the instructions are executed by a processor, steps of the method according to the first aspect are implemented.

According to a sixth aspect, a chip is provided. The chip includes a processor and a communication interface. The communication interface is coupled to the processor. The processor is configured to run a program or instructions, to implement the method according to the first aspect or implement the method according to the second aspect.

According to a seventh aspect, a computer program/program product is provided. The computer program/program product is stored in a storage medium, and the program/program product is executed by at least one processor to implement the method according to the first aspect.

### BRIEF DESCRIPTION OF THE DRAWINGS

FIG. 1 is a block diagram of a radio communication system to which an embodiment of this application is applicable;

FIG. 2 is a schematic flowchart of a sidelink-based transmission method according to an embodiment of this application;

FIG. 3 is a schematic diagram of a structure of a sidelink-based transmission apparatus according to an embodiment of this application;

FIG. 4 is a schematic diagram of a structure of a communication device according to an embodiment of this application; and

FIG. 5 is a schematic diagram of a structure of a terminal according to an embodiment of this application.

### DESCRIPTION OF EMBODIMENTS

The following clearly describes the technical solutions in embodiments of this application with reference to the accompanying drawings in embodiments of this application. It is clear that the described embodiments are a part rather than all of embodiments of this application. All other embodiments obtained by a person of ordinary skill in the art based on embodiments of this application shall fall within the protection scope of this application.

In this application, the terms “first”, “second”, and the like are intended to distinguish between similar objects but do not necessarily indicate a specific order or sequence. It should be understood that the terms used in this way are exchangeable in a proper case, so that the embodiments of this application can be implemented in an order different from the order shown or described herein, and objects distinguished by “first” and “second” are usually of a same category and a quantity of the objects is not limited. For example, there may be one or more first objects. In addition, “or” in this application indicates at least one of connected objects. For example, “A or B” covers three solutions. To be specific, a solution 1 including A and excluding B, a solution 2 is including B and excluding A, and a solution 3 is including both A and B. A character “/” usually indicates an “or” relationship between the associated objects.

The term “indication” in this application may be a direct indication (in other words, an explicit indication) or an indirect indication (in other words, an implicit indication). The direct indication may be understood as that a sending party clearly notifies, in a sent indication, a receiving party of content such as specific information, a to-be-executed operation, or a request result. The indirect indication may be understood as that the receiving party determines corresponding information based on the indication sent by the sending party, or performs determining and determines a to-be-executed operation or a request result based on a determining result.

It should be noted that, the technology described in the embodiments of this application is not limited to a long term evolution (LTE)/LTE-advanced (LTE-A) system, but may be further used in other wireless communication systems, such as code division multiple access (CDMA), time division multiple access (TDMA), frequency division multiple access (FDMA), orthogonal frequency division multiple access, (OFDMA), single-carrier frequency-division multiple access (SC-FDMA), or another system. The terms “system” and “network” in the embodiments of this application are usually interchangeably used, and the technologies described may be applied to the systems and radio technologies mentioned above, and may also be applied to other systems and radio technologies. The following descriptions describe a new radio (NR) system for illustration, and NR terms are used in most of the following descriptions, but these technologies can also be applied to a system other than the NR system, such as a 6th generation (6G) communication system.

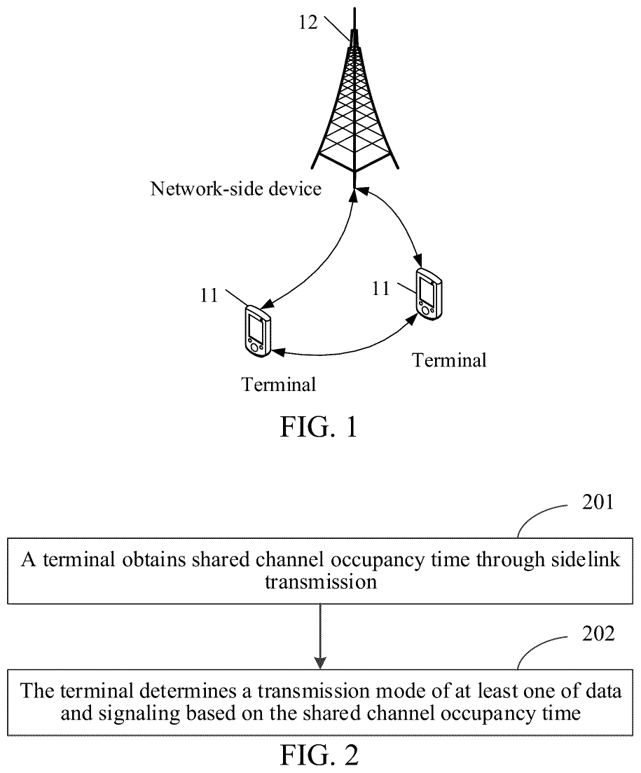

FIG. 1 is a block diagram of a radio communication system to which an embodiment of this application is applicable. The radio communication system includes a terminal 11 and a network-side device 12. The terminal 11 may be a terminal side device like a mobile phone, a tablet computer (Tablet Personal Computer), a laptop computer, a notebook computer, a personal digital assistant (PDA), a palmtop computer, a netbook, an ultra-mobile personal computer (UMPC), a mobile internet device (MID), augmented reality (AR), a virtual reality (VR) device, a robot, a wearable device, a flight vehicle, vehicle user equipment (VUE), an on-ship device, pedestrian user equipment (PUE), a smart home appliance (a home device with a wireless communication function, for example, a refrigerator, a television, a washing machine, or furniture), a game console, a personal computer (PC), a teller machine, or a self-service machine. The wearable device includes a smart watch, a smart band, a smart headset, smart glasses, smart jewelry (a smart bracelet, a smart hand chain, a smart ring, a smart necklace, a smart bangle, a smart anklet, and the like), a smart wrist strap, a smart dress, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in embodiments of this application. The network-side device 12 may include an access network device or a core network device. The access network device may alternatively be referred to as a radio access network (RAN) device, a radio access network function, or a radio access network unit. The access network device may include a base station, a wireless local area network (WLAN) access point (AS), a wireless fidelity (Wi-Fi) node, or the like. The base station may be referred to as a Node B (NB), an evolved Node B (eNB), a next generation Node B (gNB), a new radio Node B (NR Node B), an access point, a relay base station (RBS), a serving base station (SBS), a base transceiver station (BTS), a radio base station, a radio transceiver, a basic service set (BSS), an extended service set (ESS), a home Node B (HNB), a home evolved Node B, a transmission reception point (TRP) or another suitable term in the field. As long as the same technical effect is achieved, the base station is not limited to a specific technical word. It should be noted that, the base station in the NR system is used only as an example for description in embodiments of this application, but a specific type of the base station is not limited.

To better understand the technical solutions of this application, the following content is first described:

### 1. Descriptions of a Sidelink

From a released version 12, a long term evolution (LTE) system starts to support a sidelink (which may also be referred to as a secondary link, a side link, or the like), which is used for direct data transmission between terminal user equipment (UE) without using a network device.

UE sends sidelink control information (SCI) through a physical sidelink control channel (PSCCH), and schedules transmission of a physical sidelink shared channel (PSSCH) to send data. The transmission is in a broadcast form, and a receiving end does not feed back, to a sending end, whether receiving succeeds.

An LTE sidelink design supports two resource allocation modes, which are respectively a scheduled resource allocation mode and an autonomous resource selection mode. The former is that a network-side device controls and allocates a resource for each UE, and the latter is that the UE autonomously selects a resource.

From a released version 15, the LTE supports sidelink carrier aggregation (CA). CA of an LTE sidelink is different from a Uu interface (that is, a downlink and an uplink), and there is no difference between a primary component carrier (PCC) and a secondary component carrier (SCC). The UE in the autonomous resource selection mode independently performs resource sensing and resource reservation on each CC.

The LTE sidelink design is suitable for specific public safety affairs (such as emergency communication in fire or earthquake disaster areas), vehicle to everything (V2X) communication, or the like. The vehicle to everything communication includes various services, such as basic security communication, advanced (autonomous) driving, fleet formation, and sensor extension. The LTE sidelink supports only broadcast communication, and therefore is mainly used for basic security communication, and other advanced V2X services are supported by an NR sidelink.

A 5G NR system may be used in an operating frequency band above 6 GHz that is not supported by the LTE, and supports a larger operating bandwidth. However, a current-version NR system supports only an interface between a base station and a terminal, and does not support a Sidelink interface for direct communication between terminals.

Specifically, in a ProSe network architecture, a communication interface between a terminal and a terminal is referred to as a PC5 interface, and an interface that connects a terminal to an access network device like an E-UTRAN is referred to as a Uu interface.

### 2. A Transmission Form of a Sidelink

Currently, sidelink transmission mainly includes several transmission forms: broadcast, groupcast, and unicast. The unicast, as the name implies, is transmission of one to one. The groupcast is transmission of one to many. The broadcast is also transmission of one to many, but the broadcast does not have the concept that UEs belong to a same group.

Currently, the Sidelink unicast and groupcast communication support a physical layer hybrid automatic repeat request (HTTP) feedback mechanism.

In addition, two modes are defined for an NR sidelink. As shown below, one mode is mode1, where a base station schedules resources; and the other mode is mode2, where the UE independently determines which resource is used for transmission. In this case, resource information may be from a broadcast message of the base station or pre-configured. If the UE operates in a range of the base station and has an RRC connection to the base station, the UE may be in at least one of the mode1 and the mode2. If the UE operates in the range of the base station but has no RRC connection to the base station, the UE can operate only in the mode2. If the UE is out of the range of the base station, the UE can operate only in the mode2, and performs V2X transmission based on pre-configured information. The mode2 may be further divided into 2a, 2b, 2c, and 2d.

### 3. Resource Pool

Currently, during V2X transmission, there is a concept of a “resource pool”. The resource pool is sent or pre-configured by a network side, and the resource pool includes resources used for transmission and many transmission-related parameters, for example, in the LTE, includes an offset value of a first sub-frame of the resource pool, a bitmap corresponding to the resource pool, whether a PSCCH and a PSSCH are transmitted between adjacent resource blocks (RB), a number of sub-channels, a size of each sub-channel, a lowest RB index value corresponding to a sub-channel, a lowest RB index value corresponding to a PSSCH pool, a sidelink received signal strength indication (S-RSSI) threshold measured based on a channel busy rate (CBR), an area identifier, and the like.

Currently, in addition to configuring a common transmission resource pool for UE, the network side may further configure an exceptional pool. The exceptional pool is used in some special cases, for example, occurrence of a radio link failure (RLF) in a switching process or a process of switching from an IDLE state to a CONNECTED state.

For UE under different network coverages, a resource pool and a corresponding resource may be selected based on network scheduling, or the resource pool may be autonomously selected based on pre-configuration. A resource pool may need to be selected in consideration of an area in which the UE is located, to select a resource pool related to the area. A resource in the resource pool is mainly selected autonomously based on a sensing mechanism, or may be selected randomly (for example, selection of a resource in the exceptional pool).

### 4. Sidelink Logical Channel Prioritization (LCP)

A basic logic is similar to that of Uu LCP. However, on a sidelink, transmit (TX) UE may need to simultaneously send data to a plurality of receive (RX) UEs. Therefore, a destination corresponding to a logical channel (or a medium access control control element (MAC CE)) with a highest priority needs to be first selected from logical channels (or MAC CEs) that satisfy all conditions (if data is available, a type and an index corresponding to a configured grant satisfy conditions, a HARQ attribute satisfies a condition, and the like). In other words, an object at a peer end of sending is determined. Then, for all logical channels belonging to the destination, it is further determined whether all conditions are satisfied, and a logical channel is selected for reusing.

### 5. Technical Descriptions of a Sidelink in an Unlicensed Spectrum

For an SL-U (a sidelink in an unlicensed spectrum), a channel needs to be obtained through listen before talk (LBT) before SL data is sent. The following briefly describes the LBT technology.

In a future communication system, a shared spectrum like an unlicensed band may be used as a supplement to a licensed band to help an operator expand services. To be consistent with NR deployment and to maximize NR-based unlicensed access as much as possible, the unlicensed band may be operated in frequency bands such as 5 GHz, 37 GHz, and 60 GHz. Because the unlicensed band is shared by a plurality of technologies (RATs), for example, Wi-Fi, radar, and LTE-license assisted access (LTE-LAA), in some countries or areas, the unlicensed band needs to satisfy regulations during use to ensure that all devices can fairly use the resource, for example, regulations like LBT (listen before talk) and maximum channel occupancy time (MCOT). When a transmission node needs to send information, the transmission node needs to first perform LBT, and perform energy detection (ED) on surrounding nodes. When detected energy is less than a threshold, it is considered that a channel is idle, and the transmission node may perform sending. Otherwise, it is considered that the channel is busy, and the transmission node cannot perform sending. The transmission node may be a base station, UE, a Wi-Fi AP, or the like. After the transmission node starts transmission, channel occupancy time COT cannot exceed the MCOT. In addition, according to an occupied channel bandwidth (OCB) regulation, in the unlicensed band, the transmission node needs to occupy a bandwidth of at least 70% (60 GHz) or 80% (5 GHZ) of an entire frequency band during transmission each time.

Commonly used LBT types in an NRU may be classified into Type1, Type2A, Type2B, and Type2C. The Type1 LBT is a back-off-based channel sensing mechanism. When the transmission node senses that a channel is busy, the transmission node performs back-off, and continues performing sensing until the transmission node senses that the channel is idle. The Type2C means that the sending node does not perform LBT, that is, no LBT is performed or immediate transmission is performed. The Type2A and Type2B LBT are one-shot LBT, that is, the node performs LBT once before transmission, and performs transmission when the channel is idle, or does not perform transmission when the channel is busy. A difference is as follows: In the Type2A, LBT is performed within 25 us. This is applicable to a case that a gap between two times of transmission is greater than or equal to 25 us during COT sharing. However, in the Type2B, LBT is performed within 16 us. This is applicable to a case that a gap between two times of transmission is equal to 16 us during COT sharing. In addition, there is also Type2 LBT, applicable to LAA/eLAA/FeLAA. During COT sharing, a gap between two times of transmission is greater than or equal to 25 us, and an eNB and UE may use the Type2 LBT. In addition, in the frequency range 2-2, LBT types include Type1, Type2, and Type3. Type1 is a back-off-based channel sensing mechanism. Type2 is one-shot LBT, where 5 us LBT is performed within 8 us. Type3 is not performing LBT.

### Channel Access Priority Class (CAPC)

Before preempting a channel, the eNB/gNB/UE needs to determine a CAPC value, and accordingly look up a table (for example, the following Table 1) to determine a window parameter for channel access and LBT. The CAPC value is p=1 to 4, where p=1 represents a highest priority, and a corresponding LBT window is shorter than an LBT window corresponding to another priority. In other words, time required for successful LBT by using p=1 is shorter than average time for successful LBT by using p=2/3/4. However, a length of maximum occupied COT is correspondingly shorter. This shows, to some extent, fairness of different devices in preempting a channel.

For p=3 and p=4, if it can be ensured in a long term that no other RAT shares the channel, T_{m cot,p}=10 ms; otherwise, T_{m cot,p}=8 ms.

TABLE 1
Channel Access Priority Class (CAPC)

| Channel | | | | | |
|---|---|---|---|---|---|
| Access | | | | | |
| Priority | | | | | allowed CWₚ |
| Class (p) | mₚ | CW_{min, p} | CW_{max, p} | T_{mcot, p} | sizes |
| 1 | 1 | 3 | 7 | 2 ms | {3, 7} |
| 2 | 1 | 7 | 15 | 3 ms | {7, 15} |
| 3 | 3 | 15 | 63 | 8 ms or | {15, 31, 63} |
| | | | | 10 ms | |
| 4 | 7 | 15 | 1023 | 8 ms or | {15, 31, 63, 127, |
| | | | | 10 ms | 255, 511, 1023} |

When the UE performs LBT because the UE needs to send uplink data, the UE needs to determine a CAPC value of this LBT based on a type of the to-be-sent data and a manner agreed in a protocol or configured by a network. When the data that needs to be sent by the UE includes data carried in an SRB0/SRB1/SRB3, p=1 is always used by default. For an SRB2/DRB, the network side may configure, for the UE, a CAPC value for data carried in the SRB2 or the data radio bearer (DRB).

The sidelink-based transmission method provided in embodiments of this application is described in detail below with reference to the accompanying drawings through some embodiments and application scenarios thereof.

As shown in FIG. 2, an embodiment of this application provides a sidelink-based transmission method. The method is performed by a terminal, and the method includes the following steps.

Step 201: The terminal obtains shared COT through sidelink transmission.

Step 202: The terminal determines a transmission mode of at least one of data and signaling based on the shared COT.

In this embodiment of this application, the terminal obtains the shared COT from another terminal through sidelink transmission, determines the transmission mode of at least one of the data and the signaling based on the obtained shared COT, and performs correct transmission processing of at least one of the data and the signaling in a sidelink scenario.

It should be noted that the terminal that obtains the shared COT may also be referred to as a responding terminal (responding UE), and the terminal that provides the shared COT may also be referred to as an initiating terminal (initiating UE).

The following describes a specific manner in which the terminal determines the transmission mode of at least one of the data and the signaling based on the shared COT.

In a possible implementation, that the terminal determines the transmission mode of at least one of the data and the signaling based on the shared COT includes:
(1) the terminal performs a destination selection procedure, to select a selected destination that satisfies a first condition; and
(2) a target destination of at least one of the data and the signaling is determined based on the selected destination that satisfies the first condition.

The first condition includes any one of the following:
(1) a destination is the same as a source layer-2 identifier (source L2 ID) of the terminal that shares the COT with the terminal, in other words, the destination is the same as a source L2 ID of the initiating UE;
(2) a destination is the same as or associated with a terminal identifier (UE ID) carried in the shared COT, where it should be noted that if the shared COT carries an L2 ID, the destination is the same as the terminal identifier, or if an ID in another form is carried, the destination is associated with the terminal identifier; or
(3) a destination is the same as an L2 ID corresponding to a groupcast or broadcast service in which the terminal is interested, in other words, the destination is the same as an L2 ID corresponding to a groupcast or broadcast service in which the responding UE is interested.

In a possible implementation, that the terminal determines the transmission mode of at least one of the data and the signaling based on the shared COT includes:
(1) the terminal performs an LCP procedure, and selects a target logical channel that satisfies at least one of a second condition or a third condition; and
(2) a media access control protocol data unit (MAC PDU) is generated based on the target logical channel.

The second condition is that a CAPC value associated with a logical channel is less than or equal to a CAPC value associated with the shared COT, and the third condition is that SBj associated with a logical channel is greater than 0, where SBj is a scheduling priority parameter of the logical channel.

It is considered that when data arrives at the UE, an LCP procedure is performed. In this embodiment of this application, in a process of selecting a logical channel by performing the LCP procedure, the shared COT is used as a selection condition, to ensure that the selected logical channel can satisfy the shared COT, that is, a correct LCP procedure is performed based on the shared COT. Specifically, a logical channel that satisfies “a CAPC value associated with a logical channel is less than or equal to a CAPC value associated with the shared COT” is selected, and a MAC PDU is generated based on the selected logical channel.

In a possible implementation, the generating a media access control protocol data unit MAC PDU based on the logical channel that satisfies the second condition includes:
(1) the terminal determines a size of a transmission resource (grant) or a transport block (TB);
(2) in a case that sizes of all allocated resources of the target logical channel do not satisfy the size of the transmission resource or the transport block, the terminal performs at least one of the following:
(2.1) reselecting a modulation and coding scheme (MCS); and
(2.2) triggering resource reselection.

In this embodiment of this application, the terminal may autonomously determine a size of a transmission resource or a transport block in advance. For example, the UE determines the size of the transport block (TB) or the size of the grant. A specific manner of determining the size of the transmission resource may be implemented by using a related technology. This is not specifically limited in embodiments of this application. In a case that sizes of allocated resources of all logical channels that satisfy at least one of the second condition and the third condition do not satisfy the size of the transmission resource or the transport block, that is, after all the logical channels that satisfy the conditions are placed into the grant, if there is still remaining space in the TB size or the grant, the terminal performs at least one of reselecting an MSC and triggering resource reselection. In some specific implementations, the UE may generate a MAC PDU through padding instead of placing an LCH whose priority is lower but whose CAPC does not satisfy a requirement, to ensure that all logical channels used for transmission can satisfy the shared COT.

It should be noted that the UE generates a TB for transmission when data arrives, and in this case, the UE may have obtained the shared COT, or may have not obtained the shared COT. Therefore, the generated TB in this case may satisfy the shared COT, or may not satisfy the shared COT. Therefore, in this embodiment of this application, regardless of whether the UE has generated the TB, the UE may use the foregoing processing manner of selecting a logical channel based on the shared COT. To be specific, if the UE obtains the shared COT before generating the TB, the UE may directly generate a TB1 based on the shared COT. If the UE obtains the shared COT after generating the TB, that is, the TB1 has been generated, a TB2 may be directly generated based on the shared COT, to ensure that a finally generated TB satisfies the shared COT.

In a possible implementation, that the terminal determines the transmission mode of at least one of the data and the signaling based on the shared COT includes:
(1) the terminal generates a first transport block TB; and
(2) in a case that a CAPC value associated with the first TB is less than or equal to a CAPC value associated with the shared COT, the terminal sends the first TB based on the shared COT.

In this embodiment of this application, it is considered that when data arrives, the UE generates the first TB for transmission, and the first TB may be recorded as a TB1. In this case, the terminal needs to determine, based on the obtained shared COT, whether the TB1 satisfies a requirement. A specific determining manner is to determine whether the CAPC value associated with the first TB is less than or equal to the CAPC value associated with the shared COT. If a determining result is yes, the terminal sends the first TB based on the shared COT. Herein, sending the first TB based on the shared COT refers to performing type-2 LBT on a resource associated with the shared COT.

It may be understood that, in this embodiment of this application, the terminal may obtain the shared COT before, after, or at the same time when the terminal generates the first TB. This is not specifically limited in embodiments of this application.

In a possible implementation, that the terminal determines the transmission mode of at least one of the data and the signaling based on the shared COT includes:
(1) the terminal generates a first TB;
(2) in a case that a CAPC value associated with the first TB is greater than a CAPC value associated with the shared COT, the terminal generates a second TB based on the shared COT; and
(3) the terminal sends a second TB based on the shared COT.

A CAPC value associated with the second TB is less than or equal to the CAPC value associated with the shared COT.

In this embodiment of this application, it is considered that when data arrives, the UE generates the first TB for transmission, and the first TB may be recorded as a TB1. In this case, the terminal needs to determine, based on the obtained shared COT, whether the TB1 satisfies a requirement. A specific determining manner is to determine whether the CAPC value associated with the first TB is less than or equal to the CAPC value associated with the shared COT. If a determining result is no, that is, the CAPC value associated with the first TB is greater than the CAPC value associated with the shared COT, the terminal generates the second TB based on the shared COT, and the second TB may be recorded as a TB2. Generation based on the shared COT means that the shared COT is considered in a TB generation process. The TB generation process includes at least one of a resource selection process and an LCP process. Then, the second TB is sent based on the shared COT. Herein, sending the second TB based on the shared COT refers to performing type-2 LBT on a resource associated with the shared COT.

In a possible implementation, the method further includes any one of the following:
(1) the terminal drops the first TB;
(2) the terminal pends (pending) the first TB, and selects at least one of a first initial-transmission resource and a first retransmission resource that are associated with the first TB, to transmit the first TB; or
(3) the terminal pends (pending) the first TB, and re-associates a hybrid automatic repeat request process HARQ process corresponding to the first TB to at least one of a second initial-transmission resource and a second retransmission resource.

The second initial-transmission resource is different from the first initial-transmission resource, and the second retransmission resource is different from the first retransmission resource.

In this embodiment of this application, in a case that the UE already generates a TB1 and then generates a TB2 based on the shared COT, for the already generated TB1, the UE may process the TB1 in the foregoing processing manners (1) to (3), to avoid a resource waste.

In a possible implementation, the method further includes at least one of the following:
(1) initiating a resource selection or reselection procedure, where the resource selection or reselection procedure ensures that a selected resource is in a resource block set (RB Set) associated with the shared COT or overlaps with the RB Set associated with the shared COT;
(2) in a case that type-1 LBT has been started, stopping the type-1 LBT; and
(3) performing type-2 LBT on the resource that is in the RB Set associated with the shared COT or overlaps with the RB Set associated with the shared COT.

It should be noted that, the foregoing (1) to (3) are specifically processing operations that can be further performed in the process of sending the first TB or the second TB based on the shared COT, to further clarify a resource for transmission.

In a possible implementation, that the terminal determines the transmission mode of at least one of the data and the signaling based on the shared COT includes:
(1) the terminal generates a first TB; and
(2) in a case that a CAPC value associated with the first TB is greater than a CAPC value associated with the shared COT, the UE ignores the shared COT and continues performing type-1 LBT.

In a possible implementation, the method further includes:
(1) the terminal obtains an association relationship configured by a network-side device, where the association relationship indicates that a modulation and coding scheme table (MCS table) is associated with a first value;
(2) the terminal determines one or more MCS tables based on the first value and the association relationship; and
(3) the terminal determines an MCS value based on the one or more MCS tables.

The first value includes at least one of the following:
(1) a priority value corresponding to a logical channel;
(2) a channel busy rate (CBR) value, for example, a CBR value obtained through measurement by the terminal; and
(3) a CAPC value.

The MCS table includes one or more MCS values, and the UE may determine an MCS value according to the MCS table, to perform subsequent processing such as TB generation. In this embodiment of this application, the network side configures an association relationship for the UE, and specifically, indicates that the MCS table is associated with the first value. In this way, the terminal can determine the associated MCS table based on the association relationship and the first value, to determine an MCS value.

In a possible implementation, that the terminal determines one or more MCS tables based on the association relationship includes:

the terminal determines the one or more MCS tables based on the association relationship and at least one of the following:
(1) a priority value corresponding to a logical channel with a highest priority;
(2) a priority value corresponding to a logical channel with a lowest priority;
(3) a CBR value obtained through measurement by the terminal;
(4) a pre-configured CBR value;
(5) a CAPC value corresponding to the logical channel with the highest priority;
(6) a CAPC value corresponding to the logical channel with the lowest priority;
(7) a smallest CAPC value in CAPC values corresponding to all logical channels; and
(8) a largest CAPC value in the CAPC values corresponding to all the logical channels.

A specific embodiment is as follows:

For example, the network side configures:
an MSC table 1 is associated with the CAPC value 1 and the CBR=X;
an MSC table 2 is associated with the CAPC value 2 and the CBR=Y; and
an MSC table 3 is associated with the CAPC value 2 and the CBR=Z.

After data arrives, the UE performs a resource selection and LCP procedure. In this case, a CAPC value associated with a logical channel with a highest priority of the UE is 2, and a CBR obtained through measurement by the UE is Z. Therefore, the UE selects the MCS table 3.

The foregoing embodiment describes a case in which two dimensions (CBR and CAPC) are used to determine an MCS table. The same determining manner is used for a case of three dimensions (CBR, CAPC, and priority).

For example, the network side configures:
the MSC table 1 is associated with the CAPC value 1, CBR=X, and priority=a;
the MSC table 2 is associated with the CAPC value 2, CBR=Y, and priority=b; and
the MSC table 3 is associated with the CAPC value 2, CBR=Z, and priority=c.

After data arrives, the UE performs a resource selection and LCP procedure. In this case, a CAPC value associated with a logical channel with a highest priority of the UE is 2, a CBR obtained through measurement by the UE is Z, and a priority value corresponding to the logical channel with the highest priority is priority=c. Therefore, the UE selects the MCS table 3.

It should be noted that, one or more MCS tables may be determined in the foregoing manner. In a case that one MCS table is determined, an MCS value is determined based on an upper limit and a lower limit of the MCS table. For example, an MCS value is randomly selected between an MCS upper limit and an MCS lower limit corresponding to the MCS table. In a case that a plurality of MCS tables are determined, an intersection of upper limits and lower limits of the plurality of MCS tables may be first selected, and then an MCS value is determined based on an upper limit and a lower limit of the intersection. For example, an MCS value is randomly selected between the MCS upper limit and the MCS lower limit corresponding to the intersection.

In a possible implementation, the method further includes:
the terminal obtains an association relationship configured by a network-side device, where the association relationship indicates that an MCS value is associated with a first value.

The first value includes at least one of the following:
(1) a priority value corresponding to a logical channel;
(2) a channel busy rate (CBR) value, for example, a CBR value obtained through measurement by the terminal; and
(3) a CAPC value.

In this embodiment of this application, the network side configures the association relationship between the MCS value and the first value. In this way, the terminal may directly determine a final MCS value based on the association relationship.

In a possible implementation, the method further includes:
the terminal determines to use the shared COT in a case that the third condition is satisfied.

The third condition includes at least one of the following:
(1) a CAPC value associated with a logical channel currently with a highest priority is less than or equal to a CAPC value associated with the shared COT;
(2) a CAPC value associated with a logical channel currently with a lowest priority is less than or equal to the CAPC value associated with the shared COT;
(3) a smallest CAPC value in CAPC values associated with all current logical channels is less than or equal to the CAPC value associated with the shared COT;
(4) a largest CAPC value in the CAPC values associated with all the current logical channels is less than or equal to the CAPC value associated with the shared COT;
(5) current to-be-transmitted content includes at least a media access control control element MAC CE;
(6) the current to-be-transmitted content includes at least a sidelink control channel SCCH;
(7) there is currently at least one logical channel whose associated CAPC value is less than or equal to the CAPC value associated with the shared COT;
(8) the CAPC values associated with all the current logical channels are all less than or equal to the CAPC value associated with the shared COT;
(9) there is an overlapped part between a resource corresponding to a currently selected sidelink grant and the shared COT in at least one of time domain and frequency domain;
(10) a type-2 listen before talk type-2 LBT access mode is allowed to be used for the current MAC CE, the current SCCH, or the logical channel currently with the highest priority; and
(11) the type-2 LBT access mode is allowed to be used for a currently generated TB.

In this embodiment of this application, after obtaining the shared COT, the UE may determine, according to the foregoing conditions (1) to (11), whether to use the shared COT, where a specific case in which the UE can use the shared COT is clarified.

In a possible implementation, in the case that there is an overlapped part between the resource corresponding to the used sidelink grant and the shared COT in at least one of time domain and frequency domain, the method further includes:
(1) the terminal uses a resource in the overlapped part as available COT or available shared COT, and determining a target transmission resource based on the available COT or the available shared COT; or
(2) the terminal uses a resource in the overlapped part as a final selected grant, and determining a target transmission resource based on the final selected grant.

In this embodiment of this application, the used sidelink grant may be understood as a currently selected sidelink grant. A resource corresponding to the currently selected sidelink grant is a resource selected by the UE when data arrives. The shared COT is not considered when the resource is selected. If there is an overlapped part between the resource and the shared COT in at least one of time domain and frequency domain, the overlapped part may be used as a final transmission resource. For example, the final transmission resource is determined by taking an intersection of the resource and the shared COT. The final transmission resource may be referred to as available COT, available shared COT, or a final selected grant.

The following describes the technical solutions in this application with reference to specific embodiments.

### Embodiment 1

Step 1: The UE performs resource selection when data arrives.

Step 2: The UE receives shared COT. Step 2 may occur before step 1 or at the same time as step 1.

Step 3: If a smallest CAPC value in CAPC values associated with all current logical channels of data of the UE is less than or equal to a CAPC value associated with the shared COT (it should be noted that this condition is merely an optional condition for determining whether to use the shared COT, and for another optional condition, refer to related content of the third condition above), the UE uses the shared COT. The UE takes an intersection of a resource selected in step 1 and an RB set corresponding to the shared COT, to obtain a final transmission resource.

Step 4: The UE performs an LCP procedure based on the resource in step 3. In the LCP procedure, when the UE selects a logical channel, the logical channel needs to satisfy the following condition:
a CAPC value associated with the logical channel is less than the CAPC value associated with shared COT.

Step 5: The UE completes the LCP procedure, generates a MAC PDU, and performs type-2 LBT on the resource in step 3.

Step 6: The UE sends data based on an LBT result.

### Embodiment 2

For each PSSCH duration:

Step 1: UE receives or selects a sidelink grant, where the sidelink grant occurs in this PSSCH duration.

Step 2: The UE selects an MCS table based on a configuration of a resource pool in which the sidelink grant is located.

Step 3: When the UE operates in mode-2, the UE determines an MCS value based on the following steps:
(1) determining an upper limit 1 and a lower limit 1 of an MCS based on sl-PSSCH-TxConfigList configured on the network side, and
determining an upper limit 2 and a lower limit 2 of the MCS based on sl-CBR-PriorityTxConfigList configured on the network side, where the upper limit 2 and the lower limit 2 of the MCS are determined based on a priority corresponding to a logical channel with a highest priority in logical channels of the UE and a CBR value obtained through measurement by the UE (or a configured default CBR value when there is no available measured CBR value); and
(2) determining an upper limit 3 and a lower limit 3 of the MCS based on a mapping relationship, configured on the network side, between a CAPC and an MCS table, where the upper limit 3 and the lower limit 3 of the MCS are determined based on one of the following CAPC values:
(1) a CAPC value associated with a logical channel currently with a highest priority is less than or equal to a CAPC value associated with the shared COT;
(2) a CAPC value associated with a logical channel currently with a lowest priority is less than or equal to the CAPC value associated with the shared COT;
(3) a smallest CAPC value in CAPC values associated with all current logical channels is less than or equal to the CAPC value associated with the shared COT;
(4) a largest CAPC value in the CAPC values associated with all the current logical channels is less than or equal to the CAPC value associated with the shared COT;

Step 4: The UE selects an MCS value randomly or based on an implementation, and makes the MCS value be in an overlapping range between a range from the lower limit 1 to the upper limit 1, a range from the lower limit 2 to the upper limit 2, and a range from the lower limit 3 to the upper limit 3.

Step 5: The UE submits a finally determined MCS value to a HARQ entity.

### Embodiment 3

Step 1: The UE performs resource selection when data arrives.

Step 2: After completing resource selection, the UE performs an LCP procedure and generates a TB1.

Step 3: The UE receives shared COT. Step 3 may be at any position before steps 1 and 2, between steps 1 and 2, or after steps 1 and 2.

Step 4: If the UE determines that a CAPC value of the TB1 is greater than or equal to a CAPC value associated with the shared COT, the UE determines a new transmission resource based on the shared COT, and performs LCP to generate a TB2.

Step 5: The UE transmits the TB2 by using the new transmission resource. For the TB1, the UE performs one of the following operations:
(1) dropping the TB1; or
(2) pending the TB1, and further, transmitting the TB1 in the following manners:
(2.1) transmitting the TB1 by using a retransmission resource selected by the UE for the TB1; and
(2.2) re-associating a HARQ process corresponding to the TB1 with at least one of a new initial transmission resource or a new retransmission resource, and performing subsequent transmission.

### Embodiment 4

Step 1: The UE performs resource selection when data arrives.

Step 2: After completing resource selection, the UE performs an LCP procedure and generates a TB1.

Step 3: The UE receives shared COT. Step 3 may be at any position before steps 1 and 2, between steps 1 and 2, or after steps 1 and 2.

Step 4: If the UE determines that a CAPC value of the TB1 is less than or equal to a CAPC value associated with the shared COT, the UE determines a new transmission resource by using the shared COT, performs LBT by using type-2 access, and transmits the TB1 based on an LBT result.

The sidelink-based transmission method provided in embodiments of this application may be performed by a sidelink-based transmission apparatus. In embodiments of this application, the sidelink-based transmission apparatus provided in embodiments of this application is described by using an example in which the sidelink-based transmission apparatus performs the sidelink-based transmission method.

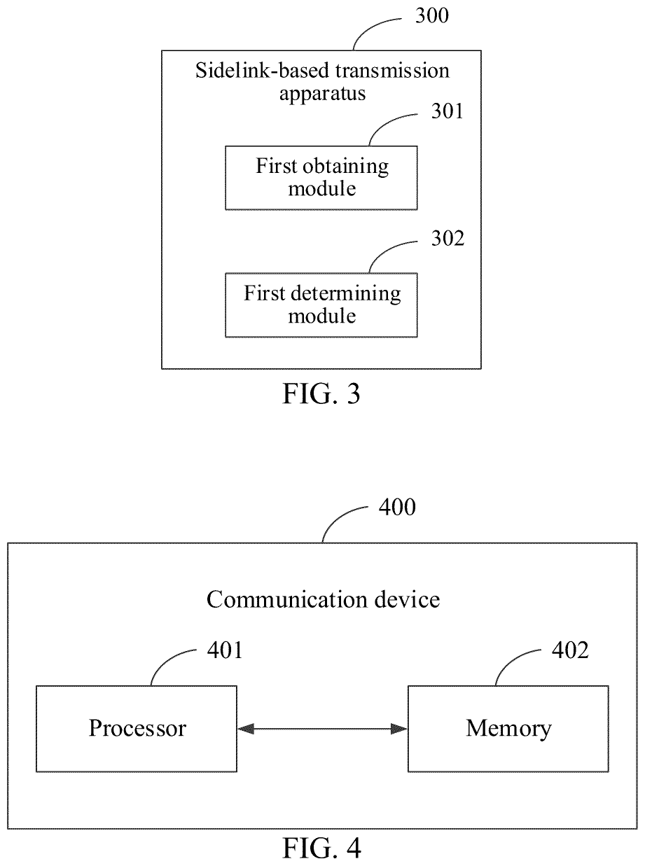

As shown in FIG. 3, an embodiment of this application provides a sidelink-based transmission apparatus 300. The apparatus may be used in a terminal, and the apparatus includes:
a first obtaining module 301, used for obtaining, by the terminal, shared COT through sidelink transmission; and
a first determining module 302, used for determining, by the terminal, a transmission mode of at least one of data and signaling based on the shared COT.

Optionally, the first determining module is specifically used for:
performing, by the terminal, a destination selection procedure, to select a selected destination that satisfies a first condition; and
determining a target destination of at least one of the data and the signaling based on the selected destination that satisfies the first condition, where
the first condition includes any one of the following:
a destination is the same as a source L2 ID of a terminal that shares the COT with the terminal;
a destination is the same as or associated with a UE ID carried in the shared COT; or
a destination is the same as an L2 ID corresponding to a groupcast or broadcast service in which the terminal is interested.

Optionally, the first determining module is specifically used for:
performing, by the terminal, an LCP procedure, and selecting a target logical channel that satisfies at least one of a second condition or a third condition; and
generating a MAC PDU based on the target logical channel, where
the second condition is that a CAPC value associated with a logical channel is less than or equal to a CAPC value associated with the shared COT, and the third condition is that SBj associated with a logical channel is greater than 0, where SBj is a scheduling priority parameter of the logical channel.

Optionally, the first determining module is specifically used for:
determining, by the terminal, a size of a transmission resource or a transport block; and
in a case that sizes of all allocated resources of the target logical channel do not satisfy the size of the transmission resource or the transport block, performing, by the terminal, at least one of the following:
reselecting an MCS; and
triggering resource reselection.

Optionally, the first determining module is specifically used for:
generating, by the terminal, a first TB; and
in a case that a CAPC value associated with the first TB is less than or equal to a CAPC value associated with the shared COT, sending, by the terminal, the first TB based on the shared COT.

Optionally, the first determining module is specifically used for:
generating, by the terminal, a first TB;
in a case that a CAPC value associated with the first TB is greater than a CAPC value associated with the shared COT, generating, by the terminal, a second TB based on the shared COT; and
sending, by the terminal, the second TB based on the shared COT, where
a CAPC value associated with the second TB is less than or equal to the CAPC value associated with the shared COT.

Optionally, the apparatus further includes:
a first processing module, used for performing any one of the following:
dropping, by the terminal, the first TB;
pending, by the terminal, the first TB, and selecting at least one of a first initial-transmission resource and a first retransmission resource that are associated with the first TB, to transmit the first TB; or
pending, by the terminal, the first TB, and re-associating a HARQ process corresponding to the first TB to at least one of a second initial-transmission resource and a second retransmission resource, where
the second initial-transmission resource is different from the first initial-transmission resource, and the second retransmission resource is different from the first retransmission resource.

Optionally, the apparatus further includes:
a second processing module, used for performing at least one of the following:
initiating a resource selection or reselection procedure, where the resource selection or reselection procedure ensures that a selected resource is in an RB Set associated with the shared COT or overlaps with the RB Set associated with the shared COT;
in a case that type-1 LBT has been started, stopping the type-1 LBT; and
performing type-2 LBT on the resource that is in the RB Set associated with the shared COT or overlaps with the RB Set associated with the shared COT.

Optionally, the determining, by the terminal, a transmission mode of at least one of data and signaling based on the shared COT includes:
generating, by the terminal, a first TB; and
in a case that a CAPC value associated with the first TB is greater than a CAPC value associated with the shared COT, ignoring, by the UE, the shared COT and continuing performing type-1 LBT.

Optionally, the apparatus further includes:
a second obtaining module, used for obtaining, by the terminal, an association relationship configured by a network-side device, where the association relationship indicates that an MCS table is associated with a first value; and
a second determining module, used for: determining, by the terminal, one or more MCS tables based on the first value and the association relationship; and
determining, by the terminal, an MCS value based on the one or more MCS tables, where the first value includes at least one of the following:
a priority value corresponding to a logical channel;
a CBR value; and
a CAPC value.

Optionally, the second determining module is specifically used for:
determining, by the terminal, the one or more MCS tables based on the association relationship and at least one of the following:
a priority value corresponding to a logical channel with a highest priority;
a priority value corresponding to a logical channel with a lowest priority;
a CBR value obtained through measurement by the terminal;
a pre-configured CBR value;
a CAPC value corresponding to the logical channel with the highest priority;
a CAPC value corresponding to the logical channel with the lowest priority;
a smallest CAPC value in CAPC values corresponding to all logical channels; and
a largest CAPC value in the CAPC values corresponding to all the logical channels.

Optionally, the apparatus further includes:
a third determining module, used for determining, by the terminal, to use the shared COT in a case that a fourth condition is satisfied, where
the fourth condition includes at least one of the following:
a CAPC value associated with a logical channel currently with a highest priority is less than or equal to a CAPC value associated with the shared COT;
a CAPC value associated with a logical channel currently with a lowest priority is less than or equal to the CAPC value associated with the shared COT;
a smallest CAPC value in CAPC values associated with all current logical channels is less than or equal to the CAPC value associated with the shared COT;
a largest CAPC value in the CAPC values associated with all the current logical channels is less than or equal to the CAPC value associated with the shared COT;
current to-be-transmitted content includes at least a MAC CE;
the current to-be-transmitted content includes at least an SCCH;
there is currently at least one logical channel whose associated CAPC value is less than or equal to the CAPC value associated with the shared COT;
the CAPC values associated with all the current logical channels are all less than or equal to the CAPC value associated with the shared COT;
there is an overlapped part between a resource corresponding to a currently selected sidelink grant and the shared COT in at least one of time domain and frequency domain;
a type-2 LBT access mode is allowed to be used for the current MAC CE, the current SCCH, or the logical channel currently with the highest priority; and
the type-2 LBT access mode is allowed to be used for a currently generated TB.

Optionally, the apparatus further includes:
a fourth determining module, where in the case that there is an overlapped part between the resource corresponding to the used sidelink grant and the shared COT in at least one of time domain and frequency domain, the fourth determining module is specifically used for:
using, by the terminal, a resource in the overlapped part as available COT or available shared COT, and determining a target transmission resource based on the available COT or the available shared COT;
or
using, by the terminal, a resource in the overlapped part as a final selected grant, and determining a target transmission resource based on the final selected grant.

The sidelink-based transmission apparatus in this embodiment of this application may be an electronic device, for example, an electronic device having an operating system, or a component in an electronic device, for example, an integrated circuit or a chip. The electronic device may be a terminal, or may be a device other than a terminal. For example, the terminal may include but is not limited to the foregoing listed types of the terminal 11, and the another device may be a server, a network attached storage (NAS), or the like. This is not specifically limited in embodiments of this application.

The sidelink-based transmission apparatus provided in this embodiment of this application can implement each process implemented in the method embodiment in FIG. 2, and the same technical effects can be achieved. To avoid repetition, details are not described herein again.

As shown in FIG. 4, an embodiment of this application further provides a communication device 400, including a processor 401 and a memory 402. The memory 402 stores a program or instructions runnable on the processor 401. For example, when the communication device 400 is a terminal, and the program or the instructions are executed by the processor 401, the steps in the foregoing embodiments of the sidelink-based transmission method are implemented, and the same technical effects can be achieved.

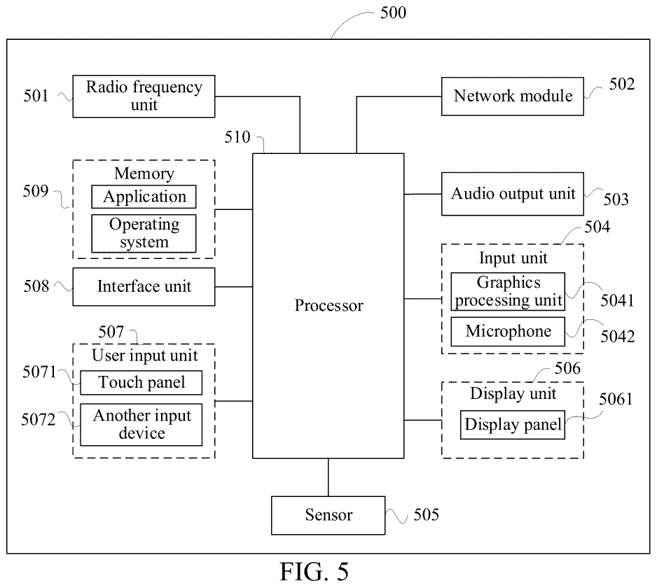

An embodiment of this application further provides a terminal, including a processor and a communication interface. The communication interface is coupled to the processor, and the processor is configured to run a program or instructions, to implement the steps in the method embodiments shown in FIG. 2. This terminal embodiment corresponds to the foregoing method embodiments on the terminal side. Each implementation process and implementation of the foregoing method embodiments may be applied to this terminal embodiment, and the same technical effects can be achieved. Specifically, FIG. 5 is a schematic diagram of a hardware structure of a terminal according to an embodiment of this application.

The terminal 500 includes but is not limited to at least some components in a radio frequency unit 501, a network module 502, an audio output unit 503, an input unit 504, a sensor 505, a display unit 506, a user input unit 507, an interface unit 508, a memory 509, and a processor 510.

A person skilled in the art may understand that the terminal 500 may further include a power supply (for example, a battery) that supplies power to each component. The power supply may be logically connected to the processor 510 through a power management system, so that functions such as charging management, discharging management, and power consumption management are implemented through the power management system. The terminal structure shown in FIG. 5 does not constitute a limitation on the terminal. The terminal may include more or fewer components than those shown in the figure, or some components may be combined, or different component arrangements may be used. Details are not described herein again.

It should be understood that in this embodiment of this application, the input unit 504 may include a graphics processing unit (GPU) 5041 and a microphone 5042, and the graphics processing unit 5041 processes a static picture or video image data obtained by an image capturing apparatus (for example, a camera) in a video capturing mode or an image capturing mode. The display unit 506 may include a display panel 5061, and the display panel 5061 may be configured in a form of a liquid crystal display, an organic light-emitting diode, or the like. The user input unit 507 includes at least one of a touch panel 5071 and another input device 5072. The touch panel 5071 is also referred to as a touchscreen. The touch panel 5071 may include two parts: a touch detection apparatus and a touch controller. The another input device 5072 may include but is not limited to a physical keyboard, a function key (such as a volume control key or a switch key), a track ball, a mouse, and a joystick. Details are not described herein again.

In this embodiment of this application, the radio frequency unit 501 receives downlink data from a network-side device and then transmits the data to the processor 510 for processing. In addition, the radio frequency unit 501 may send uplink data to the network-side device. Generally, the radio frequency unit 501 includes but is not limited to an antenna, an amplifier, a transceiver, a coupler, a low noise amplifier, a duplexer, and the like.

The memory 509 may be configured to store a software program or instructions and various data. The memory 509 may mainly include a first storage area that stores a program or instructions and a second storage area that stores data, where the first storage area may store an operating system, an application or an instruction required for at least one function (for example, a sound playing function, an image display function, and the like), and the like. In addition, the memory 509 may include a volatile memory or a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct rambus random access memory (Direct Rambus RAM, DRRAM). The memory 509 in this embodiment of this application includes but is not limited to these memories and any other memory of a suitable type.

The processor 510 may include one or more processing units. Optionally, the processor 510 integrates an application processor and a modem processor. The application processor mainly processes operations related to an operating system, a user interface, an application, and the like. The modem processor mainly processes wireless communication signals, and is, for example, a baseband processor. It may be understood that the modem processor may not be integrated into the processor 510.

The radio frequency unit 501 is used by the terminal to obtain shared COT through sidelink transmission.

The processor 510 is used by the terminal to determine a transmission mode of at least one of data and signaling based on the shared COT.

Optionally, the processor 510 is specifically used for:
performing, by the terminal, a destination selection procedure, to select a selected destination that satisfies a first condition; and
determining a target destination of at least one of the data and the signaling based on the selected destination that satisfies the first condition, where
the first condition includes any one of the following:
a destination is the same as a source L2 ID of a terminal that shares the COT with the terminal;
a destination is the same as or associated with a UE ID carried in the shared COT; or
a destination is the same as an L2 ID corresponding to a groupcast or broadcast service in which the terminal is interested.

Optionally, the processor 510 is specifically used for:
performing, by the terminal, an LCP procedure, and selecting a target logical channel that satisfies at least one of a second condition or a third condition; and
generating a MAC PDU based on the target logical channel, where
the second condition is that a CAPC value associated with a logical channel is less than or equal to a CAPC value associated with the shared COT, and the third condition is that SBj associated with a logical channel is greater than 0, where SBj is a scheduling priority parameter of the logical channel.

Optionally, the processor 510 is specifically used for:
determining, by the terminal, a size of a transmission resource or a transport block; and
in a case that sizes of all allocated resources of the target logical channel do not satisfy the size of the transmission resource or the transport block, performing, by the terminal, at least one of the following:
reselecting an MCS; and
triggering resource reselection.

Optionally, the processor 510 is specifically used for:
generating, by the terminal, a first TB; and
in a case that a CAPC value associated with the first TB is less than or equal to a CAPC value associated with the shared COT, sending, by the terminal, the first TB based on the shared COT.

Optionally, the processor 510 is specifically used for:
generating, by the terminal, a first TB;
in a case that a CAPC value associated with the first TB is greater than a CAPC value associated with the shared COT, generating, by the terminal, a second TB based on the shared COT; and
sending, by the terminal, the second TB based on the shared COT, where
a CAPC value associated with the second TB is less than or equal to the CAPC value associated with the shared COT.

Optionally, the processor 510 is used for any one of the following:
dropping, by the terminal, the first TB;
pending, by the terminal, the first TB, and selecting at least one of a first initial-transmission resource and a first retransmission resource that are associated with the first TB, to transmit the first TB; or
pending, by the terminal, the first TB, and re-associating a HARQ process corresponding to the first TB to at least one of a second initial-transmission resource and a second retransmission resource, where
the second initial-transmission resource is different from the first initial-transmission resource, and the second retransmission resource is different from the first retransmission resource.

Optionally, the processor 510 is specifically used for at least one of the following:
initiating a resource selection or reselection procedure, where the resource selection or reselection procedure ensures that a selected resource is in an RB Set associated with the shared COT or overlaps with the RB Set associated with the shared COT;
in a case that type-1 LBT has been started, stopping the type-1 LBT; and
performing type-2 LBT on the resource that is in the RB Set associated with the shared COT or overlaps with the RB Set associated with the shared COT.

Optionally, the determining, by the terminal, a transmission mode of at least one of data and signaling based on the shared COT includes:
generating, by the terminal, a first TB; and
in a case that a CAPC value associated with the first TB is greater than a CAPC value associated with the shared COT, ignoring, by the UE, the shared COT and continuing performing type-1 LBT.

Optionally, the processor 510 is used for obtaining, by the terminal, an association relationship configured by a network-side device, where the association relationship indicates that an MCS table is associated with a first value.

The processor 510 is used for: determining, by the terminal, one or more MCS tables based on the first value and the association relationship; and
determining, by the terminal, an MCS value based on the one or more MCS tables, where the first value includes at least one of the following:
a priority value corresponding to a logical channel;
a CBR value; and
a CAPC value.

Optionally, the processor 510 is specifically used for:
determining, by the terminal, the one or more MCS tables based on the association relationship and at least one of the following:
a priority value corresponding to a logical channel with a highest priority;
a priority value corresponding to a logical channel with a lowest priority;
a CBR value obtained through measurement by the terminal;
a pre-configured CBR value;
a CAPC value corresponding to the logical channel with the highest priority;
a CAPC value corresponding to the logical channel with the lowest priority;
a smallest CAPC value in CAPC values corresponding to all logical channels; and
a largest CAPC value in the CAPC values corresponding to all the logical channels.

Optionally, the processor 510 is used for determining, by the terminal, to use the shared COT in a case that a fourth condition is satisfied, where
the fourth condition includes at least one of the following:
a CAPC value associated with a logical channel currently with a highest priority is less than or equal to a CAPC value associated with the shared COT;
a CAPC value associated with a logical channel currently with a lowest priority is less than or equal to the CAPC value associated with the shared COT;
a smallest CAPC value in CAPC values associated with all current logical channels is less than or equal to the CAPC value associated with the shared COT;
a largest CAPC value in the CAPC values associated with all the current logical channels is less than or equal to the CAPC value associated with the shared COT;
current to-be-transmitted content includes at least a MAC CE;
the current to-be-transmitted content includes at least an SCCH;
there is currently at least one logical channel whose associated CAPC value is less than or equal to the CAPC value associated with the shared COT;
the CAPC values associated with all the current logical channels are all less than or equal to the CAPC value associated with the shared COT;
there is an overlapped part between a resource corresponding to a currently selected sidelink grant and the shared COT in at least one of time domain and frequency domain;
a type-2 LBT access mode is allowed to be used for the current MAC CE, the current SCCH, or the logical channel currently with the highest priority; and
the type-2 LBT access mode is allowed to be used for a currently generated TB.

Optionally, in the case that there is an overlapped part between the resource corresponding to the used sidelink grant and the shared COT in at least one of time domain and frequency domain, the processor 510 is specifically used for:
using, by the terminal, a resource in the overlapped part as available COT or available shared COT, and determining a target transmission resource based on the available COT or the available shared COT;
or
using, by the terminal, a resource in the overlapped part as a final selected grant, and determining a target transmission resource based on the final selected grant.

It may be understood that, for an implementation process of each implementation mentioned in this embodiment, refer to related descriptions in the method embodiments, and the same or corresponding technical effects are achieved. To avoid repetition, details are not described herein again.

An embodiment of the present application further provides a chip. The chip includes a processor and a communication interface. The communication interface is coupled to the processor. The processor is configured to run a program or instructions, to implement the processes in embodiments of the sidelink-based transmission method, and the same technical effects can be achieved. To avoid repetition, details are not described herein again.

It should be understood that the chip mentioned in this embodiment of this application may alternatively be referred to as a system on chip, a system chip, a chip system, a system on a chip, or the like.

An embodiment of this application further provides a computer program/program product. The computer program/program product is stored in a non-volatile or non-transitory readable storage medium, and the computer program/program product is executed by at least one processor, to implement the processes in execute of the sidelink-based transmission method, and the same technical effects can be achieved. To avoid repetition, details are not described herein again.

It is worthwhile to note that, in this specification, the terms “include”, “comprise”, or any other variants thereof are intended to cover a non-exclusive inclusion, so that a process, a method, a thing, or an apparatus that includes a list of elements not only includes those elements but also includes other elements which are not expressly listed, or further includes elements inherent to such a process, method, thing, or apparatus. An element limited by a phrase “includes a . . . ” does not, without more limitations, preclude existence of an additional identical element in a process, method, object, or apparatus that includes the element. Moreover, it should be noted that the scope of the method and apparatus of embodiments of this application is not limited to performing functions in the order shown or discussed, but may further include performing functions in a substantially concurrent manner or in reverse order depending on the related function. For example, the described method may be performed in an order different from that described, and various steps may be further added, omitted, or combined. Moreover, features described with reference to some examples may be combined in other examples.

According to the descriptions in the foregoing implementations, a person skilled in the art may clearly learn that the method according to the foregoing embodiments may be implemented by a computer software product and a necessary general hardware platform, or certainly, by using hardware. The computer software product is stored in a storage medium (such as an ROM, an RAM, a magnetic disk, or an optical disc) and includes several instructions for instructing a terminal or a network-side device to perform the methods described in embodiments of this application.

The foregoing describes embodiments of this application with reference to the accompanying drawings. However, this application is not limited to the foregoing specific implementations. The foregoing specific implementations are merely examples, but are not limitative. Inspired by this application, persons of ordinary skill in the art may further make implementations in many forms without departing from the purposes of this application and the protection scope of the claims, and all the implementations shall fall within the protection of this application.

What is claimed is:

1. A sidelink-based transmission method, comprising:
obtaining, by a terminal, shared channel occupancy time (shared COT) through sidelink transmission; and
determining, by the terminal, a transmission mode of at least one of data or signaling based on the shared COT.

2. The method according to claim 1, wherein the determining, by the terminal, a transmission mode of at least one of data or signaling based on the shared COT comprises:
performing, by the terminal, a destination selection procedure, to select a selected destination that satisfies a first condition; and
determining a target destination of at least one of the data or the signaling based on the selected destination, wherein
the first condition comprises any one of the following:
a destination is the same as a source layer-2 identifier (source L2 ID) of a terminal that shares the COT with the terminal;
a destination is the same as or associated with a terminal identifier (UE ID) carried in the shared COT; or
a destination is the same as an L2 ID corresponding to a groupcast or broadcast service in which the terminal is interested.

3. The method according to claim 1, wherein the determining, by the terminal, a transmission mode of at least one of data or signaling based on the shared COT comprises:
performing, by the terminal, a logical channel prioritization (LCP) procedure, and selecting a target logical channel that satisfies at least one of a second condition or a third condition; and
generating a media access control protocol data unit (MAC PDU) based on the target logical channel, wherein
the second condition is that a channel access priority class (CAPC) value associated with a logical channel is less than or equal to a CAPC value associated with the shared COT, and the third condition is that SBj associated with a logical channel is greater than 0, wherein SBj is a scheduling priority parameter of the logical channel.

4. The method according to claim 3, wherein the generating a media access control protocol data unit (MAC PDU) based on the target logical channel comprises:
determining, by the terminal, a size of a transmission resource or a transport block; and
in a case that sizes of all allocated resources of the target logical channel do not satisfy the size of the transmission resource or the transport block, performing, by the terminal, at least one of the following:
reselecting a modulation and coding scheme (MCS); or
triggering resource reselection.

5. The method according to claim 1, wherein the determining, by the terminal, a transmission mode of at least one of data or signaling based on the shared COT comprises:
generating, by the terminal, a first transport block (TB); and
in a case that a CAPC value associated with the first TB is less than or equal to a CAPC value associated with the shared COT, sending, by the terminal, the first TB based on the shared COT.

6. The method according to claim 1, wherein the determining, by the terminal, a transmission mode of at least one of data or signaling based on the shared COT comprises:
generating, by the terminal, a first TB;
in a case that a CAPC value associated with the first TB is greater than a CAPC value associated with the shared COT, generating, by the terminal, a second TB based on the shared COT; and
sending, by the terminal, the second TB based on the shared COT, wherein
a CAPC value associated with the second TB is less than or equal to the CAPC value associated with the shared COT.

7. The method according to claim 6, wherein the method further comprises any one of the following:
dropping, by the terminal, the first TB;
pending, by the terminal, the first TB, and selecting at least one of a first initial-transmission resource or a first retransmission resource that are associated with the first TB, to transmit the first TB; or
pending, by the terminal, the first TB, and re-associating a hybrid automatic repeat request process (HARQ process) corresponding to the first TB to at least one of a second initial-transmission resource or a second retransmission resource, wherein
the second initial-transmission resource is different from the first initial-transmission resource, and the second retransmission resource is different from the first retransmission resource.

8. The method according to claim 5, wherein the method further comprises at least one of the following:
initiating, by the terminal, a resource selection or reselection procedure, wherein the resource selection or reselection procedure ensures that a selected resource is in a resource block set (RB Set) associated with the shared COT or overlaps with the RB Set associated with the shared COT;
in a case that type-1 listen before talk (type-1 LBT) has been started, stopping the type-1 LBT; or
performing type-2 listen before talk (type-2 LBT) on the resource that is in the RB Set associated with the shared COT or overlaps with the RB Set associated with the shared COT.

9. The method according to claim 1, wherein the determining, by the terminal, a transmission mode of at least one of data or signaling based on the shared COT comprises:
generating, by the terminal, a first TB; and
in a case that a CAPC value associated with the first TB is greater than a CAPC value associated with the shared COT, ignoring, by the UE, the shared COT and continuing performing type-1 LBT.

10. The method according to claim 1, wherein the method further comprises:
obtaining, by the terminal, an association relationship configured by a network-side device, wherein the association relationship indicates that a modulation and coding scheme table (MCS table) is associated with a first value;
determining, by the terminal, one or more MCS tables based on the first value and the association relationship; and
determining, by the terminal, an MCS value based on the one or more MCS tables, wherein
the first value comprises at least one of the following:
a priority value corresponding to a logical channel;
a channel busy rate (CBR) value; or
a CAPC value.

11. The method according to claim 10, wherein the determining, by the terminal, one or more MCS tables based on the first value and the association relationship comprises:
determining, by the terminal, the one or more MCS tables based on the association relationship and at least one of the following:
a priority value corresponding to a logical channel with a highest priority;
a priority value corresponding to a logical channel with a lowest priority;
a CBR value obtained through measurement by the terminal;
a pre-configured CBR value;
a CAPC value corresponding to the logical channel with the highest priority;
a CAPC value corresponding to the logical channel with the lowest priority;
a smallest CAPC value in CAPC values corresponding to all logical channels; or
a largest CAPC value in the CAPC values corresponding to all the logical channels.

12. The method according to claim 1, wherein the method further comprises:
determining, by the terminal, to use the shared COT in a case that a fourth condition is satisfied, wherein
the fourth condition comprises at least one of the following:
a CAPC value associated with a logical channel currently with a highest priority is less than or equal to a CAPC value associated with the shared COT;
a CAPC value associated with a logical channel currently with a lowest priority is less than or equal to the CAPC value associated with the shared COT;
a smallest CAPC value in CAPC values associated with all current logical channels is less than or equal to the CAPC value associated with the shared COT;
a largest CAPC value in the CAPC values associated with all the current logical channels is less than or equal to the CAPC value associated with the shared COT;
current to-be-transmitted content comprises at least a media access control control element (MAC CE);
the current to-be-transmitted content comprises at least a sidelink control channel (SCCH);
there is currently at least one logical channel whose associated CAPC value is less than or equal to the CAPC value associated with the shared COT;
the CAPC values associated with all the current logical channels are all less than or equal to the CAPC value associated with the shared COT;
there is an overlapped part between a resource corresponding to a currently selected sidelink grant and the shared COT in at least one of time domain and frequency domain;
a type-2 LBT access mode is allowed to be used for the current MAC CE, the current SCCH, or the logical channel currently with the highest priority; or
the type-2 LBT access mode is allowed to be used for a currently generated TB.

13. The method according to claim 12, wherein in the case that there is an overlapped part between the resource corresponding to the used sidelink grant and the shared COT in at least one of time domain or frequency domain, the method further comprises:
using, by the terminal, a resource in the overlapped part as available channel occupancy time (available COT) or available shared channel occupancy time (available shared COT), and determining a target transmission resource based on the available COT or the available shared COT;
or
using, by the terminal, a resource in the overlapped part as a final selected grant, and determining a target transmission resource based on the final selected grant.

14. A terminal, comprising a processor and a memory, wherein the memory stores a program or instructions runnable on the processor, wherein the program or the instructions, when executed by the processor, cause the terminal to perform:
obtaining shared channel occupancy time (shared COT) through sidelink transmission; and
determining a transmission mode of at least one of data or signaling based on the shared COT.

15. The terminal according to claim 14, wherein when determining a transmission mode of at least one of data or signaling based on the shared COT, the program or the instructions, when executed by the processor, cause the terminal to perform:
performing a destination selection procedure, to select a selected destination that satisfies a first condition; and
determining a target destination of at least one of the data or the signaling based on the selected destination, wherein
the first condition comprises any one of the following:
a destination is the same as a source layer-2 identifier (source L2 ID) of a terminal that shares the COT with the terminal;
a destination is the same as or associated with a terminal identifier (UE ID) carried in the shared COT; or
a destination is the same as an L2 ID corresponding to a groupcast or broadcast service in which the terminal is interested.

16. The terminal according to claim 14, wherein when determining a transmission mode of at least one of data or signaling based on the shared COT, the program or the instructions, when executed by the processor, cause the terminal to perform:
performing a logical channel prioritization (LCP) procedure, and selecting a target logical channel that satisfies at least one of a second condition or a third condition; and
generating a media access control protocol data unit (MAC PDU) based on the target logical channel, wherein
the second condition is that a channel access priority class (CAPC) value associated with a logical channel is less than or equal to a CAPC value associated with the shared COT, and the third condition is that SBj associated with a logical channel is greater than 0, wherein SBj is a scheduling priority parameter of the logical channel.

17. The terminal according to claim 16, wherein when generating a media access control protocol data unit (MAC PDU) based on the target logical channel, the program or the instructions, when executed by the processor, cause the terminal to perform:
determining a size of a transmission resource or a transport block; and
in a case that sizes of all allocated resources of the target logical channel do not satisfy the size of the transmission resource or the transport block, performing at least one of the following:
reselecting a modulation and coding scheme (MCS); or
triggering resource reselection.

18. A non-transitory readable storage medium, wherein the readable storage medium stores a program or instructions, wherein the program or the instructions, when executed by a processor of a terminal, cause the processor of the terminal to perform:
obtaining shared channel occupancy time (shared COT) through sidelink transmission; and
determining a transmission mode of at least one of data or signaling based on the shared COT.

19. The non-transitory readable storage medium according to claim 18, wherein when determining a transmission mode of at least one of data or signaling based on the shared COT, the program or the instructions, when executed by the processor of the terminal, cause the processor of the terminal to perform:
performing a destination selection procedure, to select a selected destination that satisfies a first condition; and
determining a target destination of at least one of the data or the signaling based on the selected destination, wherein
the first condition comprises any one of the following:
a destination is the same as a source layer-2 identifier (source L2 ID) of a terminal that shares the COT with the terminal;
a destination is the same as or associated with a terminal identifier (UE ID) carried in the shared COT; or
a destination is the same as an L2 ID corresponding to a groupcast or broadcast service in which the terminal is interested.

20. The non-transitory readable storage medium according to claim 18, wherein when determining a transmission mode of at least one of data or signaling based on the shared COT, the program or the instructions, when executed by the processor of the terminal, cause the processor of the terminal to perform:
performing a logical channel prioritization (LCP) procedure, and selecting a target logical channel that satisfies at least one of a second condition or a third condition; and
generating a media access control protocol data unit (MAC PDU) based on the target logical channel, wherein
the second condition is that a channel access priority class (CAPC) value associated with a logical channel is less than or equal to a CAPC value associated with the shared COT, and the third condition is that SBj associated with a logical channel is greater than 0, wherein SBj is a scheduling priority parameter of the logical channel.
